(19) United States
(12) Patent Application Publication
(10) Pub. No.: US 2006/0263527 A1
(43) Pub. Date: Nov. 23, 2006

(54) Method and apparatus for restoring automobile headlights

(76) Inventor: John Ripley, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/131,607

(22) Filed: May 18, 2005

(51) Int. Cl. B05D 3/10

(52) U.S. Cl. 427/301

(57) ABSTRACT

This invention comprises a method for applying a polyurethane solution to the lens headlights of automobiles. The solution is contained within a customized cylindrical application container that includes a container for storing the polyurethane and an applicator head. The applicator head fastens to the base by depressing it over a curved outer lip of the base until it is secured. The cap itself is hollow and is topped by an angled base having a hole that allows the solution to be dispensed. To assure the smooth and controlled dispersal of the solution, a rectangular sponge is attached to the top of the angled base. This sponge regulates the application of the solution to the covers of headlights and taillights of automobiles and similar vehicles. Upon application, the solution actively restores the covers by binding and filing in scratches and other abrasions on the surface. This results in a smooth surface that ensures the clear filtration of light, thereby aiding the transmission of light through the lens.

There are no related applications.

This application did not received any federal research and/or development funds.

### BACKGROUND OF THE INVENTION

The present invention relates to a method for applying a urethane or polyurethane solution to restore and clear headlights, lamps or other such lights on an automobile. This solution is contained within and applied via a customized applicator and container specially designed for its intended purpose. The applicator comprises a container for storing the urethane and an applicator head for applying the urethane onto a surface to be refinished.

Automobile headlights, headlight covers and tail lights, tend to accumulate scratches, pitting, scoring and the like resulting in a cloudy appearance. A film of grit and grime may build up on the exterior surface of the lamp. When wiped or washed off, this grit may cause additional scoring across the lamp surface. The lamp surface may become yellowish in appearance over time leaving the lamp with a dull, dingy appearance. Often this yellowing is a result of smog, dirt, UV exposure and other weather-related factors. For purposes of this application, headlights, headlight covers, tail lights, lens and lens covers are used interchangeably.

Automobile headlights comprise a lamp energized by a power system in the automobile along with a lens covering to protect the lamp. This lens is constructed in a manner to easily pass light therethrough. The aforementioned scratches, pitting, scoring, clouding and the like reduce the effectiveness and efficiency of the automobile headlight which may in turn affect the headlight's performance necessitating replacement of the headlight. It has been realized that a smoothly shaped translucent surface of a headlight lens allows light from the lamp to pass through. Uneven portions of lens will reflect, refract, diffuse, distort or otherwise adversely affect the direction and intensity of the light produced by the lamp to cause a reduction in the performance of the lamp. If the surface of the lens is reconditioned, the light passing properties of the lens may be restored.

Most of the U.S. patents addressing the aforementioned problem only discuss methods or solutions for cleaning the lens or lens covers. For example, U.S. Pat. No. 6,831,049 relates a cleaning compound within an applicator pad that is used to clean headlights and taillights of automobiles. U.S. Pat. No. 6,739,521 discloses a headlight cleaning system that operates by spraying the cover with washing liquid. In similar fashion, U.S. Pat. Nos. 3,913,166; 3,934,301; and 5,083,339 all disclose devices for cleaning headlights of automobiles. U.S. Pat. No. 6,773,761 discloses a complicated method for applying a UV varnish to car headlight reflectors. This process included selecting a varnish with a particular ambient temperature, heating the surface and the varnish, and maintaining those temperatures for a set time period. Moreover, it is believed that this process will not work on headlights having glass lenses.

While the aforementioned devices may provide an adequate means for fulfilling their singular purpose, they do not offer the user anything more. The cleansing devices mentioned in the prior art merely serve to cleanse the covers of headlight and tail lights not repair or recondition the surface to removed imperfections that adversely affect the performance of the lamp. Also significant is the lack of inventions that restore head and tail lights. Thus, there exists a continuing need for new and improved applications for the covers of head and tail lights. While the prior art provides a limited range of uses, no invention offers the user the efficiency, flexibility and ease of use present in the current method. To this end, the automotive head and taillight restoration and cleansing method substantially departs from the prior art.

### BRIEF SUMMARY OF THE INVENTION

The current invention presents a vast improvement over the disadvantages of the previously mentioned prior art. Thus, this method serves an unmet objective. It provides a solution and applicator that enhances, restores and protects the appearance and clarity of the various surfaces that cover head, tail and other exterior automotive lights. This method's dual purposes are extremely efficient enabling the user to save money, time, and effort. In addition, the flexibility of the novel angled sponge applicator ensures easy application on any type of vehicle lamp cover or lens to reduce the number of surface imperfections present on the lens cover thereby increasing the performance of the lens or lens cover. And, the customized applicator also allows the user to simply apply the solution to various surfaces: smooth, textured, plastic, or glass without creating air bubbles or other imperfections that will deteriorate the light projected through the lens. In addition, the effective solution works equally well on all types of vehicles and kinds of surfaces. Preferably, the urethane that is used in this process is sold by the Helmsman corporation as “Spar Urethane”.

The present comprises two primary parts, a method and an apparatus for restoring a lens or lens cover. A method is provided by which an operator of a motor vehicle can quickly recondition and repair a lens or lens cover to remove impurities that exist therein. The method includes first preparing the surface to be reconditioned by thoroughly cleansing it to remove dirt, grime and foreign objects. Next, an oxidizer remover may be applied to the surface that is to be treated. The oxidizer remover may comprise a slightly caustic solution such as a cleaning product that includes ammonia, vinegar or other the like. The surface area may then be wiped dry; or, alternatively rinsed with clean water and wiped dry. A layer of urethane or polyurethane is then applied to fill in the scratches, scoring and the like. After drying, additional layers of polyurethane may be applied to as necessary to create a smooth lens surface.

The applicator includes a container and an applicator tip. The applicator tip includes sponge arranged at an angle to the container. An opening is provided near the center of the sponge for flowing polyurethane from the container onto the surface to be treated. The applicator tip filters the solution smoothly from the container to the desired surface thereby assuring a smooth coating of urethane absent any air bubbles or other impurities that adversely affect the projection of light from the lamp through the lens or lens cover. The sponge also ensures that the solution is massaged into the scratches and abrasions on the surface while guaranteeing that a uniform layer of the solution is deposited across the remaining surface. Finally, the sponge polishes the surface to ensure a smooth, hard finish.

These two parts combine to create an effective method and device for both restoring headlights and the like of automobiles. When applied, the sponge dispenses the polyurethane solution smoothly over the surface. With minimal effort, the surface is cleaned and the imperfections and yellowish film eradicated by the solution. This method returns the cover to a new appearance. It also has a maintenance function as it serves to block further ultraviolet rays and thereby prevents future yellowing. Also important, no other invention restores the covers of headlights so that they look like new. This method does just that by filling in scratches, imperfections and abrasions on the surface of the cover. The polyurethane solution then dries to an invisible or translucent finish that enhances the amount of light emitted. Finally, the solution is effective on various surfaces, including plastic, polycarbonate and glass.

The above explanations are provided to illustrate the utility of the invention. And, by no means necessary were these explanations intended to limit the application of this invention to other purposes.

It is an object of the invention to provide a solution that may be deposited onto an exterior surface of a lamp assembly, lens or lens cover to restore the surface to a like new appearance. That is, the solution fills cracks, pitting, and the like to create a smooth translucent surface allowing an optimum amount of light to pass therethrough.

It is a further object of the invention to provide a novel method and apparatus that will easily and inexpensively allow a user to restore a headlight lens and/or lens cover to like new without the need for replacing the headlight lens and/or lens cover.

It is another object of the invention to provide an apparatus comprising a container for storing a polyurethane solution and an applicator for applying the solution onto a surface of an automobile light to increase the efficiency of the light transmitting properties.

These and other objects of the invention and advantages of the invention will be set forth, appear in part or become apparent after considering the specification and accompanying drawings. It is to be realized that the following embodiments of the invention have been represented in their simplest form for ease in understanding the invention.

### BRIEF DESCRIPTION OF THE DRAWINGS

FIG. 1 shows the front end of a car with two prominent headlights.

FIG. 2A depicts a headlight yellowed by UV exposure, dirt, grime and other age-related factors and including scratches or scoring marks on an exterior surface thereof. FIG. 2B shows the same headlight after treatment using the disclosed method and apparatus. In this view, the headlight is restored to a like new condition.

FIG. 3 is a cross sectional view of a lens or lens cover after having a treatment applied using the disclosed method.

FIG. 4A is a perspective view of the preferable device for treating and restoring a damaged lens or lens covering. FIG. 4B is a cross sectional view of the dispenser taken from line A-A of FIG. 4A and which is composed of a sponge adhered to a base that is attached to the container of the dispenser.

### DETAILED DESCRIPTION OF THE INVENTION

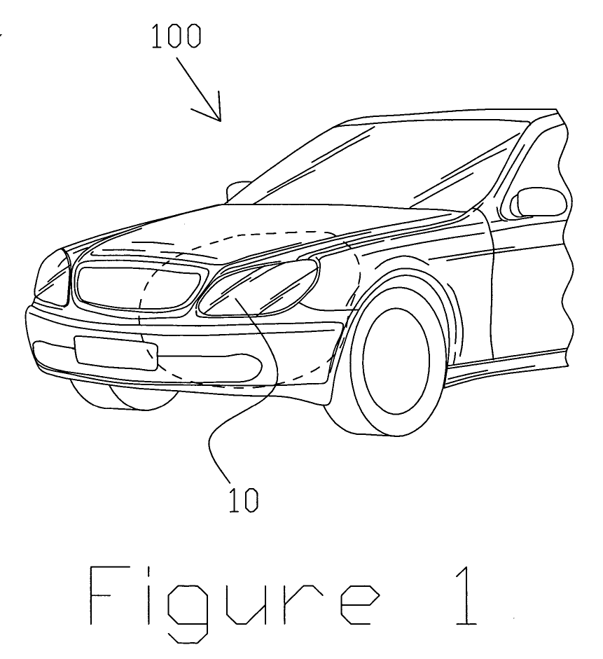

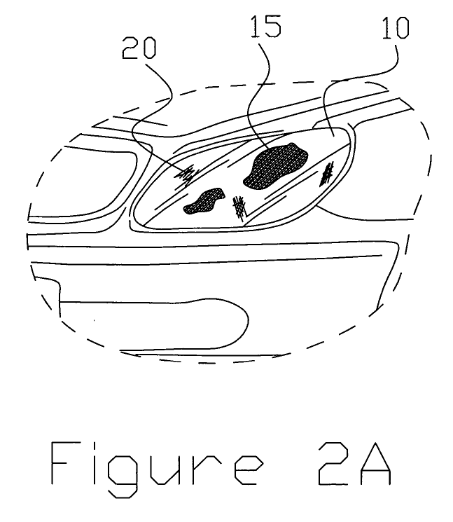

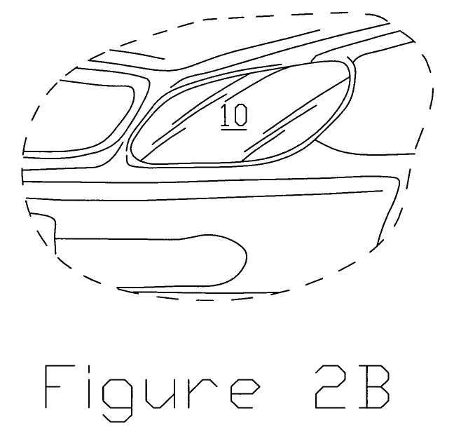

FIG. 1 depicts a front end of an automobile 100 having a headlight lens cover 10. FIG. 2A is an enlarged view of the cover 10 and showing scratches 20 and a region 15 wherein a yellowish film is present. As previously mentioned, the scratches and yellowish headlight degrades by exposure ultraviolet rays, dirt, grime and other age-related factors. FIG. 2A shows the lens 10 before being restored by the present method as shown in FIG. 2B.

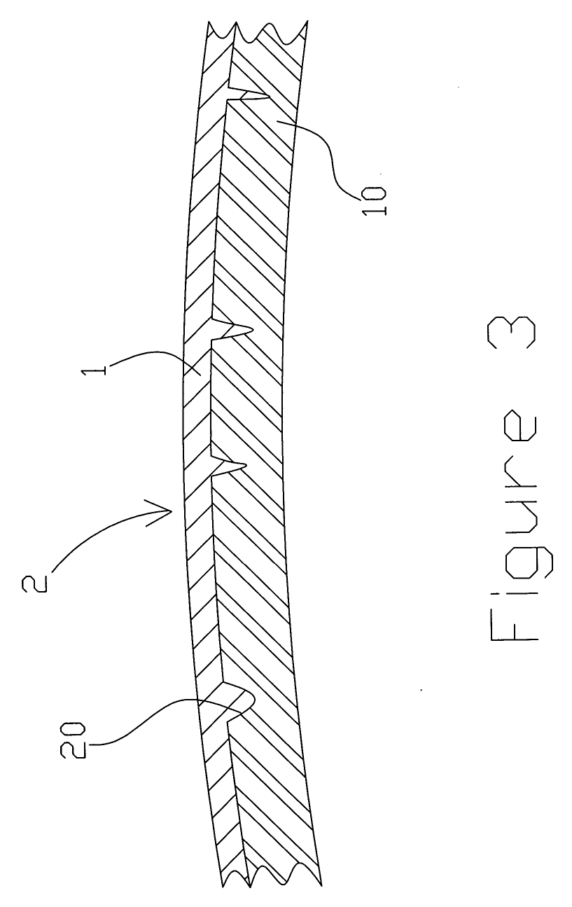

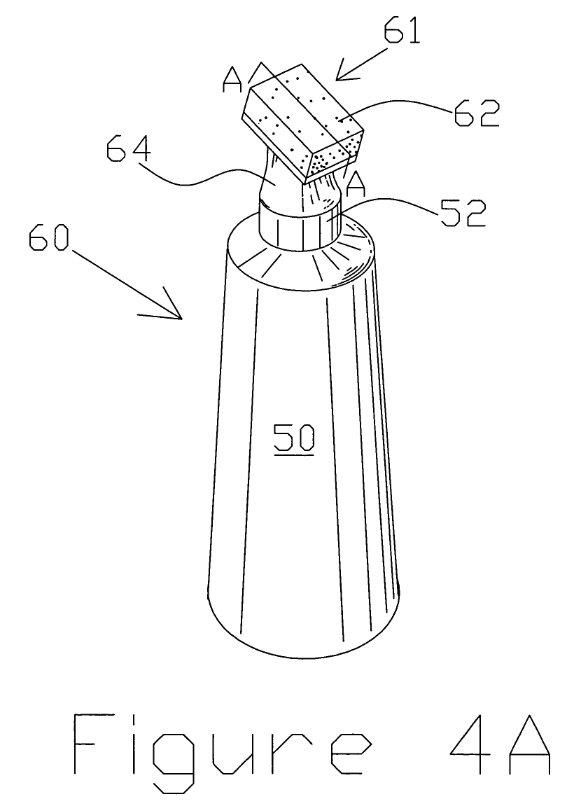

As can more clearly be seen in FIG. 3, the lens 10 comprises scratches 20 that are filled with a coating 1 of urethane. If the scratches 20 are sufficiently large, the application of a second or additional coating may be necessary to properly fill them to create a smooth surface free of impurities. It is important that the surface 2 created by the deposited urethane 1 be smooth to avoid degrading the light transmission properties of the lens 10.

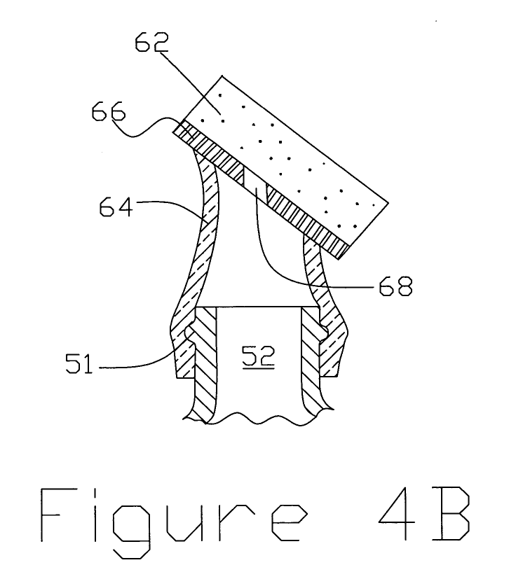

FIG. 4A denotes a novel applicator 60 for applying the urethane to the lens 10. The applicator 60 includes a container 50 for storing the polyurethane 1. Preferably, the container 50 is formed from a hard plastic or the like. The container 50 includes a neck 52 for flowing the urethane 1 from the container to an applicator head 61 that includes a base 66 having a hole 68 and an applying element 62. Typically, the applying element 62 comprises a sponge. When transferring urethane 1 from the container 50 onto a surface of the lens, the sponge operates to force the polyurethane into cracks and voids of the surface of the lens. It further acts to smooth the surface of the lens to create a layer of urethane that serves to block further ultraviolet rays from degrading the lens thereby preventing future yellowing of the lens.

The applicator head 61 further includes a rubber boot 64 that overlaps neck 52 which includes a thread 51. The applicator head 61 may be removed by simply pulling the applicator head 61 away from the container 50. In this manner, the polyurethane may be periodically replenished. The applicator head 61 further includes a base 66 to which the applying element 62 is attached.

It should be noted that the aforementioned method for restoring headlights should be interpreted broadly to include the application of the urethane by brushes, sponges or the like. Further, it is to be understood that the invention is not limited to the exact construction illustrated and described above. Various changes and modifications may be made without departing from the spirit and the scope of the invention as defined in the following claims.

I claim:

1. A method that restores an aged automobile light or lens cover, the method comprising:
removing dirt and foreign debris from a surface to be treated;
applying a urethane solution to the surface to be treated;
dispensing and smoothing said solution evenly over the surface to be treated to fill in abrasions, scratches and scoring; and
wiping any excess solution off the surface to reveal a clean, restored surface free of scratches and other abrasions.

2. The method according to claim 1, wherein said step of applying the urethane solution further comprises applying the solution through an application device comprising both a container for storing the solution and an applicator head that comprises a sponge.

3. The method of claim 1 further comprising a step of treating said surface with an oxidizer remover.

4. The method of claim 1 further comprising polishing said surface to ensure a clear, hard surface free of impurties.

5. A method that restores an automobile headlight to a new appearance, the method comprising:
removing dirt and foreign debris from a surface to be treated;
treating said surface with an oxidizer remover;
applying a urethane solution to the surface to be treated;
dispensing and smoothing said solution evenly over the surface to be treated to fill in abrasions, scratches and scoring; and
wiping any excess solution off the surface to reveal a clean, restored surface free of scratches and other abrasions.

6. The method according to claim 5, wherein said step of applying the urethane solution further comprises applying the solution through an application device comprising both a container for storing the solution and an applicator head that comprises a sponge.

7. The method of claim 5 further comprising polishing said surface to ensure a clear, hard surface free of impurties.

8. An applicator for a applying a urethane solution to a headlight to restore the headlight by filling scoring, scratches and repairing aging due to ultraviolet degradation, said applicator comprising:
a container that stores urethane, said container comprising a body that defines an area in which said urethane is deposited and a neck having a rib, said neck having an opening for refilling the container and dispensing urethane from the container; and,
an applicator head having a base that includes a rubber boot that slips over the rib on the neck to secure the applicator head to the container, said base further including an opening for dispensing urethane therethrough, and a sponge arrange above said base and fastened thereto for smoothing said urethane onto a surface of a headlight.
